(19) United States
(12) Patent Application Publication
(10) Pub. No.: US 2007/0131735 A1
(43) Pub. Date: Jun. 14, 2007

(54) Method and arrangement for friction welding

(76) Inventors: Werner Michel, Darmstadt (DE); Siegfried Eckert, Rimbach (DE); Reinhard Wagner, Heppenheim (DE)

Correspondence Address: MILDE & HOFFBERG, LLP, 10 BANK STREET, SUITE 460, WHITE PLAINS, NY, 10606, US

(21) Appl. No.: 10/573,927

(22) PCT Filed: Oct. 11, 2004
(86) PCT No.: PCT/DE04/02252

§ 371 Date: Mar. 30, 2006

(30) Foreign Application Priority Data
Oct. 11, 2003 (DE) 103 47 345.9

(51) Int. Cl. B23K 20/12

(52) U.S. Cl. 228/113

(57) ABSTRACT

Method and arrangement for friction welding, wherein one of the parts to be joined is oscillated by means of an electromagnetic oscillator. The oscillator is electrically braked after controlled stimulation of oscillations and a pre-determinable oscillation period.

The invention relates to a method and an arrangement for friction welding, whereby one of the parts to be joined is oscillated by means of an electromagnetic oscillator.

When joining parts by friction welding, heat is generated by rubbing the parts that are to be joined against one another whilst at the same time pressing them together. This has the advantage that the heat is produced directly on the surfaces that are to be joined to one another, and does not first need to be conducted through the parts to the weld junction. For generating the frictional heat, an electromagnetic oscillator is used which is provided with a holder for one of the parts that are being joined, whereas a lifting bench brings up the other part and presses it into place.

To power the oscillator, a generator produces an alternating current whose frequency is half the resonant frequency of the oscillator. Since this is also dependent on the workpiece holder on the oscillator, in the case of conventional systems it has been necessary to balance the frequency following a changeover of the workpiece holder. To this end, in the case of a system known from EP 0 481 825 A2 provision is made for a microprocessor to vary the operating frequency of the generator until the current intensity is minimal for a predetermined oscillation amplitude. However, this involves a period of time in which the system is not operating at its optimum. In order to improve this, the prior art system also provides for the frequency-dependent current profile in respect of a given tool to be ascertained and stored as a reference value. Overall, however, this does not yet mean that the shortest possible oscillation time has been obtained.

The method according to the invention makes a short welding process time possible, thanks to the fact that the oscillator is electrically braked after a controlled stimulation of oscillations and a pre-determinable oscillation time. The method according to the invention is based on recognition of the fact that the vibration is halted as immediately after the joining operation as possible, in order to avoid doing harm to the join already effected. In addition, the controlled stimulation of oscillations ensures that the resonant frequency is adjusted directly and in a fully automatic manner.

In a refinement of the method according to the invention, these advantages are particularly emphasised by the fact that the stimulation of oscillations and the braking operation are effected by alternately energising two electromagnets acting in opposing directions, that in dependence upon the respective direction of movement of the oscillator, upon stimulation of the oscillations, current is passed through an electromagnet that supports the movement and, upon braking, current is passed through an electromagnet that inhibits the respective movement, and that during the braking action the energisation process is halted once a predetermined oscillation amplitude has been reached.

Switching off the energising current once a predetermined oscillation amplitude has been reached prevents re-stimulation of the oscillations with the opposite phase relation. The predetermined oscillation amplitude is chosen so as not to put excessive strain on the joining position during the decay phase, which is now determined by the mechanical attenuation alone.

Depending upon the particular pre-requisites concerned, the transient settled condition may be maintained for a respective length of time to be determined. Particularly good results have been obtained with the method according to the invention when the stimulation of oscillations and the braking operation in each case take less than 80 ms.

In the case of one arrangement according to the invention, there is provision for one output of a displacement sensor that records the respective position of the oscillator to be connected to an input of a controller that is linked on the output side to inputs of a power-circuit output stage for energising the electromagnets. This arrangement offers a particularly straightforward way of achieving controlled stimulation without the presence of a generator that does not begin to oscillate until at a possibly incorrect frequency and thereafter needs to be synchronised.

In the case of the arrangement according to the invention it is preferred to make provision for the controller to control the power-circuit output stage so that an electromagnet supporting the movement is energised in dependence on the oscillator's respective direction of movement.

By means of a refinement of this arrangement, it is advantageously possible to perform the braking operation by energising an electromagnet that inhibits the respective movement, and by the fact that during the braking operation the energisation is halted once a predetermined oscillation amplitude has been reached. This means that the transition to the braking operation from the stimulation of oscillations, or rather from the transient settled state, to the braking action may be effected in a straightforward manner by commutation of the power-circuit output stage.

One practical further development of the arrangement according to the invention consists in the fact that the power-circuit output stage is constituted from a first bridge arm comprising two solid-state switching devices connected in series, with parallel connected free-wheeling diodes, and two further bridge armes which respectively comprise a series-parallel connection for a solid-state switching device and diode, that the coils of the electromagnets are connected, on the one hand, between the junction point of the solid-state switching devices of the first bridge arm and, on the other, a respective junction point on the other bridge arms, that the solid-state switching devices of the first bridge arm are activated at the oscillation frequency and the solid-state switching devices of the other bridge arms are activated at a higher frequency than the oscillation frequency, in a pulse-width-modulated or tolerance-band-regulated manner; higher frequencies than the oscillation frequency may result, depending on the control state.

Owing to the losses that occur with each switching operation in solid-state circuits, and in order to avoid electromagnetic malfunctions, it is endeavoured to make the switching frequencies as low as possible. One advantage of this embodiment is that it makes this procedure possible. Certain solid-state switching devices are operated at the oscillation frequency, for example 270 Hz, and other solid-state switching devices are operated a number of times per oscillation; their switching frequency remains within the range of just a few kHz. An additional frequency of not more than 15 kHz is needed to serve as a scanning frequency for registering the actual values for the current and position.

Even if it is not necessary to completely equip all the bridge arms with solid-state switching devices in the case of this practical embodiment of the invention, on account of the inexpensive modules that are available on the market it may be an advantage for the solid-state switching device diodes to be constituted with free-wheeling diodes that are connected in parallel.

The fact that switching takes place more often means that the solid-state switching devices in the other bridge arms are more heavily loaded than those in the first bridge arm. To reduce this loading, provision may be made to alternate the energisation of the electromagnets by way of the other bridge arms from one operating cycle to the next.

Another practical embodiment of the arrangement according to the invention consists in configuring means for constituting a trigger signal to energise the respective electromagnet in such a way that the trigger signal occurs a pre-determinable fraction, preferably one quarter, of the length of one oscillation after an oscillation's passage through zero.

To ensure that the stimulation of oscillations is as rapid as possible, the arrangement according to the invention may be configured in such a way that the controller incorporates an integral-action component which is pre-set at a substantial level right at the start.

A further refinement of the arrangement according to the invention consists in the fact that the oscillator, inclusive of its resilient mounting and the workpiece holder, the displacement sensor, the controller, the power-circuit output stage and the electromagnets, form an oscillating circuit whose resonant frequency is substantially determined by the natural frequency of the oscillator, inclusive of its resilient mounting and the workpiece holder. This likewise helps to speed up the stimulation of oscillations.

Examples of embodiments of the invention are illustrated in the drawing by means of several figures, and explained in more detail in the following description. In the Figures:

FIG. 1 shows a diagrammatic view of one exemple of embodiment;

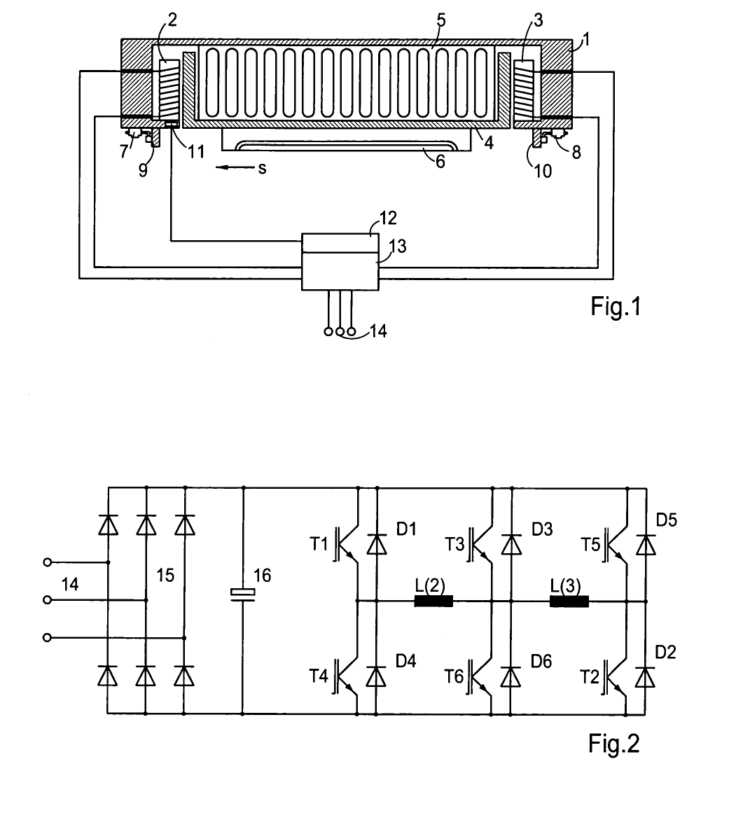

FIG. 2 shows a power-circuit output stage that can be used to particular advantage with the arrangement according to the invention;

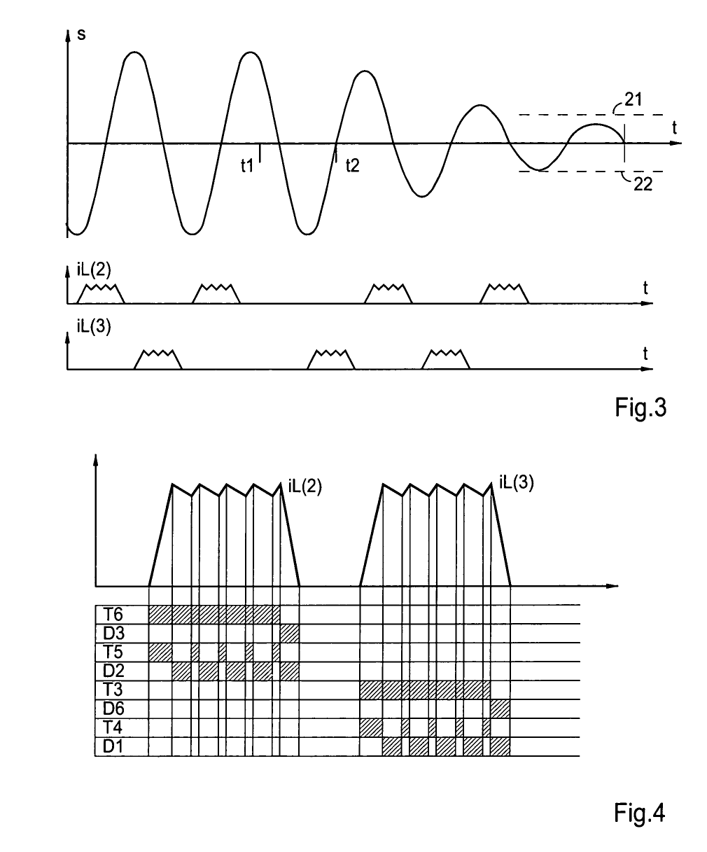

FIG. 3 shows time-dependency diagrams to explain the oscillation behaviour; and

FIG. 4 shows a view of the conductive phases of the solid-state switching devices of the power-circuit output stage.

FIG. 1 depicts those parts of a piece of friction welding equipment that are necessary in order to explain the invention. On a top bridge 1 are arranged two electromagnets 2, 3 which draw an oscillating frame 4 in their respective direction in accordance with the energisation—in the case of the electromagnet 2 in the arrowed direction s. The oscillating frame 4 is mounted on the top bridge 1 by means of a spring 5, in a manner allowing it to oscillate. The oscillating frame carries a workpiece holder 6, which is configured in accordance with the part to be joined, and can be interchanged accordingly. The oscillating frame 4, the spring 5 and the workpiece holder 6 are also referred to below simply as the oscillator.

With the help of elbow pieces 7, 8, the top bridge is mounted on brackets 9, 10 forming part of a machine that, inter alia, carries a holder (not shown) for the other part being joined, which machine is pushed onto the workpiece holder 6 for the welding operation. A displacement sensor 11 measures the respective position of the oscillating frame and forwards the measurement as a corresponding electrical signal to a controller 12. Output signals from the controller 12 are sent to a power-circuit output stage 13 which at 14 is linked in triple phase to the power supply.

An example of the power-circuit output stage 13 is depicted in greater detail in FIG. 2. The mains voltage supplied at 14 is rectified by a three-phase rectifier 15. A capacitor 16 is used to smooth out the direct voltage and to buffer the pulsating load. The arrangement depicted in FIG. 2 is manufactured in large batches as three-phase converters. A processor contained therein (not shown in FIG. 2) needs only to be suitably programmed in order to implement the invention.

The power-circuit output stage is constituted in each case by two power transistors connected in series T1, T4, T3, T6; T5, T2, to which a respective free-wheeling diode D1, D4; D3, D6; D5, D2 is connected in parallel. The middle bridge arm T3, T6 is in each case operated at the oscillation frequency in response to the oscillator's direction of movement. To regulate the oscillation amplitude, a respective one of the transistors T5 or T4 is activated at a higher frequency in a pulse-width modulated manner or with the current tolerance-band regulated. The diodes D3 and D6, respectively, of the middle bridge arm, and diodes D2 and D1 act as free-wheeling diodes. Details of the conductive output phases of the solid-state switching devices are explained further below in connection with FIG. 4.

Firstly, however, the method according to the invention will be presented with the help of FIG. 3. Diagram a shows the temporal profile of the displacement path s of the oscillator, diagrams d and c the profile of the currents iL(2) and iL(3) of the two electromagnets 2, 3 (FIG. 1). During the first three half-waves the electromagnets are energised in such a manner that the oscillation is supported. During the third half-wave, for example at instant t1, a braking command is given, whereupon in the following half-wave a pause is constituted by energising neither of the electromagnets. In the following half-waves, starting at instant t2, the respective electromagnet that brakes the oscillation is then energised, with the result that its amplitude decreases. As soon as the amplitude falls below a predetermined value 21, 22, the current is switched off in order to prevent re-stimulation in phase opposition from taking place.

FIG. 4 represents a time-dependency diagram of the current i, and shows as hatched areas the respective conductive phases of the solid-state switching devices. To energise the electromagnet 2, solid-state switching deviceer T6 is for the most part conductive during the corresponding half-wave of the phase of movement. During this time solid-state switching device T5 is cycled, and the pulse duty factor is regulated in line with the predetermined oscillation amplitude. After each occasion when the solid-state switching device T5 is switched off, the energy stored in the electromagnet causes the current to free-wheel across the diode D2 and the solid-state switching device T6. Once the solid-state switching devices T5 and T6 have been switched off, the current flows back across the diodes D2 and D3 into the capacitor and dies away very quickly on account of the latter's voltage.

Electromagnet 3 is energised in the following half-wave. The conductive phases of the solid-state switching devices

What is claimed is:

1. In a method for friction welding, in which one of the parts to be joined is oscillated by means of an electromagnetic oscillator, the improvement comprising the step of electrically braking the oscillator after the controlled stimulation of oscillations and a pre-determinable oscillation period.

2. Method according to claim 1, wherein the stimulation of oscillations and the braking action are effected by alternately energizing two electromagnets with opposing actions, wherein in dependence on the respective direction of movement of the oscillator, upon the stimulation of oscillations an electromagnet that supports the movement is energized, and upon braking, an electromagnet that inhibits the respective movement is energized, and that wherein during the braking action the energization process is halted once a predetermined oscillation amplitude has been reached.

3. Method according to claim 1, wherein the stimulation of oscillations and the braking action in each case take less than 80 ms.

4. In an arrangement for friction welding having a oscillator for oscillating parts to be joined which is powered by electromagnets with opposing actions, the improvement wherein an output of a displacement sensor which registers the respective position of the oscillator is joined to an input of a controller that is linked on the output side to inputs of a power-circuit output stage for energization of the electromagnets.

5. Arrangement according to claim 4, wherein the controller activates the power-circuit output stage in such a manner that, in dependence upon the respective direction of movement of the oscillator, an electromagnet supporting the movement is energized.

6. Arrangement according to claim 4, wherein an electromagnet inhibiting the respective movement is energized for braking, and wherein during the braking operation the energization is halted once a predetermined oscillation amplitude has been reached.

7. Arrangement according to claim 4, wherein the power-circuit output stage is constituted from a first bridge arm comprising two solid-state switching devices (T3, T6) connected in series, with parallel-connected free-running diodes (D3, D6), and two further bridge arms which respectively comprise a series-parallel connection for a solid-state switching device (T1, T2) and a diode (D4, D5); wherein coils of the electromagnets are connected on the one hand between the junction point of the solid-state switching devices (T3, T6) of the first bridge arm and, on the other hand, a respective junction point of the other bridge arms; and wherein the solid-state switching devices (T3, T6) of the first bridge arm are activated at the oscillation frequency and the solid-state switching devices (T1, T2) of the further bridge arms are activated in a pulse-width-modulated or tolerance-band-regulated manner, such that higher frequencies than the oscillation frequency can result, depending on the control state.

8. Arrangement according to claim 7, wherein the diodes (D4, D5) of solid-state switching devices (T4, T5) are constituted by free-running diodes (D4, D5) connected in parallel.

9. Arrangement according to claim 8, wherein the energization of the electromagnets is alternated by way of the other bridge arms from one operating cycle to the next.

10. Arrangement according to claim 4, wherein means for constituting a trigger signal to energize the respective electromagnet are configured in such a way that the trigger signal occurs a predeterminable fraction, preferably one quarter, of the length of an oscillation after an oscillation's passage through zero.

11. Arrangement according to claim 4, wherein the controller incorporates an integral-action component which is pre-set at a substantial level right at the start.

12. Arrangement according to claim 4, wherein the oscillator, inclusive of its resilient mounting and the workpiece holder, the displacement sensor, the controller, the power-circuit output stage and the electromagnets, form an oscillating circuit whose resonant frequency is substantially determined by the natural frequency of the oscillator, inclusive of the latter's resilient mounting and the workpiece holder.

13. Arrangement according to claim 10, wherein said fraction is one quarter.
